(19) United States
(12) Patent Application Publication
(10) Pub. No.: US 2024/0316788 A1
(43) Pub. Date: Sep. 26, 2024

(54) ROBOTIC SYSTEM FOR PERFORMING VEHICLE WHEEL MAINTENANCE

(71) Applicant: RoboTire, Inc., Canton, MI (US)

(72) Inventor: Keegan Elliott, New York, NY (US)

(21) Appl. No.: 18/124,845

(22) Filed: Mar. 22, 2023

(51) Int. Cl. B25J 11/00; B25J 9/16; B60B 29/00

(52) U.S. Cl. CPC B25J 11/008; B25J 9/1653; B25J 9/1679; B25J 9/1697; B60B 29/001; B25J 9/161; B25J 9/163; B25J 13/085

(57) ABSTRACT

A system for performing vehicle maintenance includes a robotic apparatus adapted to remove and replace a vehicle wheel and a processor that obtains the number of wheel lugs and the true radius of the wheel lugs from the true center of the wheel, then estimates the position of each lug and the center of the vehicle wheel. The estimated position of each lug is iteratively adjusted until each lug position (angles and radius) are within some margin of error. At this point a new estimate of the center is provided and the processor instructs the robotic apparatus to remove the lugs from the wheel.

### FIELD

The present disclosure relates generally to automobile maintenance, and more particularly to systems, apparatus and methods for automated removal and replacement of vehicle wheels and tires.

### Description of the Problem and Related Art

Removal of wheels from vehicle wheel hubs and placing old tires with new tires onto the removed wheels is a manual and time-intensive process. Often a vehicle is jacked up or lifted by a manually operated hydraulic lift or vehicle jack. Lug nuts are then manually removed via a torque wrench or tire iron. Once the lug nuts are removed, the wheel and tire are then physically handled and removed from a wheel-hub. Such manual operations may lead to inefficient operations, and potential physical hazards to a person removing the wheel and tire from the vehicle.

### SUMMARY

For purposes of summary, certain aspects, advantages, and novel features are described herein. It is to be understood that not necessarily all such advantages may be achieved in accordance with any one particular embodiment. Thus, the apparatuses or methods claimed may be embodied or carried out in a manner that achieves or optimizes one advantage or group of advantages as taught herein without necessarily achieving other advantages as may be taught or suggested herein.

According to a first embodiment, the system includes a robotic apparatus adapted to remove and replace a vehicle wheel and that is responsive to a processor configured to execute a computer-based method of first obtaining the number of wheel lugs and the true radius of the wheel lugs from the true center, then estimating the position of each lug and the center of the vehicle wheel. The estimated position of each lug is iteratively adjusted.

In a second embodiment, the position of each lug is iteratively adjusted by comparing estimated angles of each lug with respect to adjacent lugs to a proper angle until all angles are within some pre-determined margin of degree from the proper angle and re-estimating the center.

According to a third embodiment, the position of each lug is iteratively adjusted by comparing the estimated radius of each to the true radius until all radii are within some pre-determined margin of distance from the true radius and re-estimating the center.

In another embodiment, the system also includes a two-dimensional imaging device responsive to the processor so that a two-dimensional image of the wheel may be obtained.

In yet another embodiment, the system further comprises a three-dimensional imaging device responsive to the processor and wherein the processor generates a three-dimensional map of the wheel.

In a further embodiment, the processor further instructs the robotic apparatus to remove lug nuts from the vehicle wheel at each of the estimated new lug positions.

These and other embodiments will also become readily apparent to those skilled in the art from the following detailed description of the embodiments having reference to the attached figures.

### BRIEF DESCRIPTION OF THE DRAWINGS

The system and methods performed thereby are described with reference to the accompanying drawings. In the drawings, like reference numbers indicate identical or functionally similar elements. Additionally, the left-most digit(s) of a reference number identifies the drawing in which the reference number first appears.

FIG. 1 is a functional block diagram of an exemplary system for performing automatic vehicle wheel maintenance;

FIG. 2 depicts an exemplary automated wheel removal and wheel replacement station;

FIG. 3 is a diagram of multiple exemplary automated wheel and wheel replacement stations;

FIG. 4 is a functional block diagram of an exemplary communications network for use in the present system;

FIG. 5 is a functional block diagram of an exemplary robotic apparatus system according to an embodiment of the system;

FIG. 6 is a functional block diagram for an exemplary vehicle position determination process;

FIG. 7 is a flow diagram for a method of wheel removal;

FIG. 8 is an illustration of a robotic apparatus according to an embodiment of the present system;

FIG. 9 depicts and exemplary wheel hub with five lug nuts;

FIG. 10 is a flow diagram of an exemplary method for determining the positions of vehicle wheel lug nuts; and

FIG. 11 is a functional diagram for an exemplary computer system that may be used to implement the various embodiments.

### DETAILED DESCRIPTION

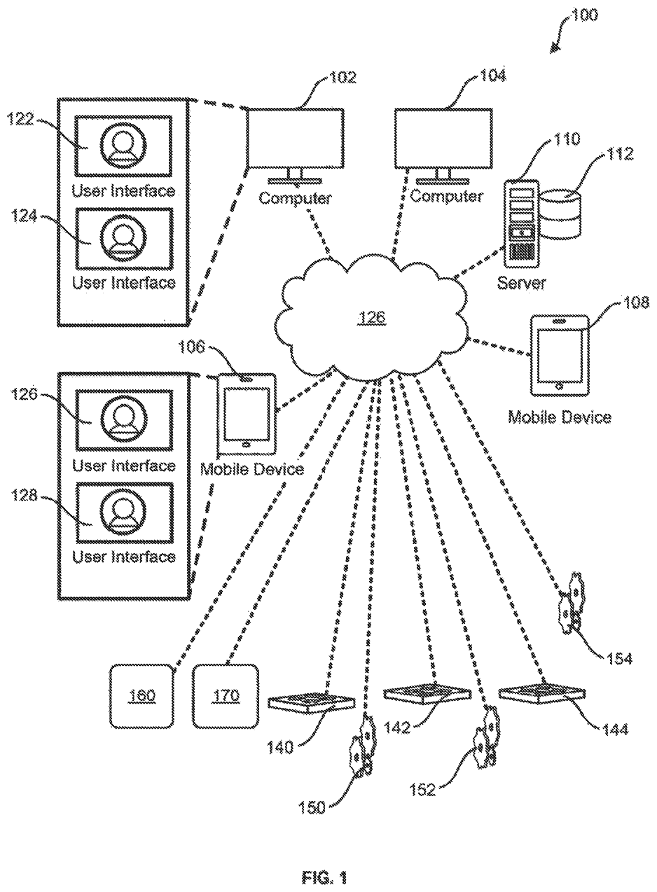

The various embodiments of the system and method disclosed herein and their advantages are best understood by referring to FIGS. 1 through 11 of the drawings. The elements of the drawings are not necessarily to scale, emphasis instead being placed upon clearly illustrating the novel features and principles of operation. Throughout the drawings, like numerals are used for like and corresponding parts of the various drawings.

Furthermore, reference in the specification to “an embodiment,” “one embodiment,” “various embodiments,” or any variant thereof means that a particular feature or aspect described in conjunction with the particular embodiment is included in at least one embodiment. Thus, the appearance of the phrases “in one embodiment,” “in another embodiment,” or variations thereof in various places throughout the specification are not necessarily all referring to its respective embodiment.

Referring to FIG. 1, exemplary system 100 for the automated removal and replacement of a wheel and tire is disclosed. System 100 can be a system of one or more computers 102, 104, 106, 108, 110 (generally referred to as 102) including software executing a method system on one or more computers 102, which is in communication with, or maintains one or more databases 112 of information. While database 112 is depicted as coupled with one computer 110, the database may be distributed, replicated in whole or part, and communicatively coupled to other computers 102. For example, portions or subsets of data may be distributed to various computers 102 to allow for local database access of information stored on database 112. The information stored by system 100 may include, but is not limited to, the following databases:

Customer Database, including fields such as cust_record_id, customer_name, customer_address, customer_phone_number.

Customer Vehicle Database, including fields such as cust_veh_record_id, vehicle_make, vehicle_model, vehicle_identification_number, vehicle_license_plate, vehicle_year, vehicle_color, desired_tire_pressure, desired_gas_type, wheel_locks.

General Vehicle Database, including fields gen_veh_record_id, vehicle_make, vehicle_model, vehicle_year, lifting_point_coordinates, lifting_height, axle_distance, tpms_type, lugnut_configuration.

Inventory Database, including fields such as inv_record_id, tire_quantity, tire_size, tire_brand, manufacturer, speed_rating, pressure_setting, location_stored, location_coordinates.

Scheduling Database including fields such as sched_record_id, cust_record_id, cust_veh_record_id, schedule_appointment_date_and_time, front_tire_SKU_numbers, rear_tire_SKU_numbers.

System 100 generates tire change jobs based on received customer information and customer vehicle information. System 100 may use the received information as control parameters to direct the control or operation of a vehicle lifting device for lifting vehicles and robotic apparatus for lug nut and wheel removal and replacement as disclosed herein. System 100 may receive and store images associated with a customer vehicle in database 112. System 100 uses image evaluation processes to perform object detection, and/or create 3-dimensional model of a wheel of a vehicle. System 100 interacts and is communicatively coupled with one or more vehicle lifting devices 140, 142, 144 (generally referred to as 140), with one or more robotic apparatus 150, 152, 154 (generally referred to as 150) and one or more tire removal/replacement machines 160, and one or more tire balancing machines 170. System 100 may include multiple interfaces 122, 124, 126, 128 (generally referred to as 122) based on the particular functionality to be performed by system 100. For example, system 100 may include a customer interface for receiving customer and vehicle information; an operator interface for control and operation of the vehicle lifting device 140, the robotic apparatus 150, the tire removal/replacement machines 160, and/or the tire balancing machines 170. Additionally, other interfaces may be utilized.

System 100 may use a computer network 126 for communication to one or more computers 102 of system 100. As described herein, the computer network 120, may include, for example, a local area network (LAN), a virtual LAN (VLAN), a wireless local area network (WLAN), a virtual private network (VPN), cellular network, wireless network, the Internet, or the like, or a combination thereof. Communication among devices of may be performed using any suitable communications protocol such as TCP/IP or EtherNET IP.

Vehicle lifting devices 140 may be communicatively coupled to system 100 via computer network 120. The vehicle lifting devices 140 may receive instructions, commands and other data from system 100. The vehicle lifting device 140 is further described herein. The vehicle lifting device 140 may include different types of sensors to obtain sensor data describing a vehicle. The sensor data obtained by the vehicle lifting device 140 may be transmitted to system 100 for analysis and/or storage into a database 112. The vehicle lifting device 140 provides a mechanism to physically lift a vehicle in a vertical manner according to a predetermined height value.

Robotic apparatus 150 may be communicatively coupled to system 100 via computer network 120. The robotic apparatus 150 may receive instructions, commands and other data from system 100. The robotic apparatus 150 may include different types of sensors integrated into the robotic apparatus 150 to obtain sensor data describing the vehicle. The sensor data obtained by the robotic apparatus 150 may be transmitted to system 100 for analysis and/or storage into a database 112. The robotic apparatus 150 provides a mechanism to physically remove a wheel from a vehicle and physically replace the wheel back onto the vehicle.

One or more tire removal machines 160 may be communicatively coupled to system 100 via computer network 120. The tire removal machine 160 may include different types of sensors integrated into the tire removal machine 160 to obtain sensor data describing a wheel and/or tire. The sensor data obtained by the tire removal machine 160 may be transmitted to system 100 for analysis and/or storage into a database 112. The tire removal machine 160 may receive one or more parameters, such as wheel size, tire size, tire pressure monitoring system (TPMS) location, desired tire inflation PSI value and/or a value for a type of gas such as air, or nitrogen to be used for tire inflation.

One or more tire balancing machines 170 may be communicatively coupled to system 100 via computer network 120. The tire balancing machine 170 may include different types of sensors integrated into the tire balancing machine 170 to obtain sensor data describing a wheel and/or tire.

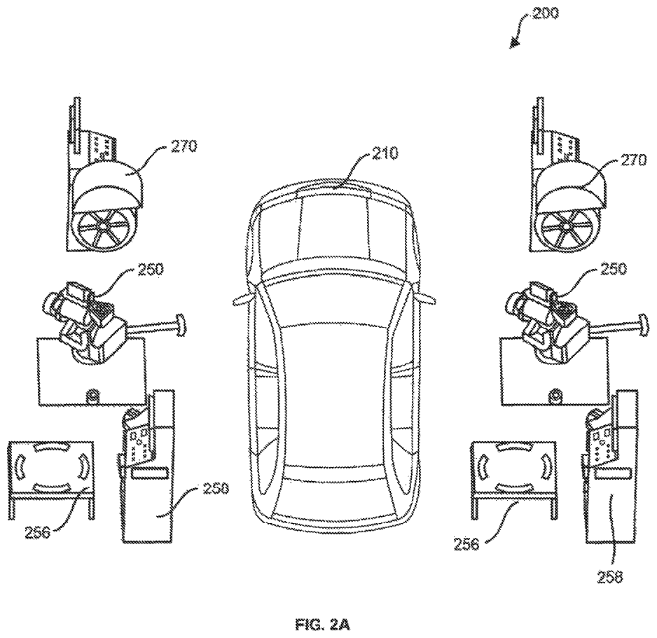

FIG. 2A illustrates an example of an automated wheel removal and wheel replacement station 200. The example illustrates a vehicle 210 positioned over a vehicle lifting device 140 (not shown). In one embodiment of the station 200, two robotic apparatus 250 (also referred to as 150 in FIG. 1) are positioned in a proximate location where the robotic apparatus 250 can interact with a vehicle 210 and manipulate the wheel fasteners, remove the wheels, and replace the wheels. Additionally, depicted are wheel holding stations 256 where the robotic apparatus 250 may place a removed wheel onto the wheel holding station 256, and/or where a wheel may be positioned in advance of the wheel being placed back onto the vehicle 210.

Additionally, a control station 258 may be used for control and operation of the robotic apparatus 250. The control station may be used for manual and/or automated control of the robotic apparatus 250. The control station 258 may receive instructions, commands and other data from system 100 (as depicted in FIG. 1). The control station 258 may be communicatively coupled to control the robotic apparatus 250. Also depicted are tire balancing machines 270 that are communicatively coupled to system 100 (as depicted in FIG. 1).

FIG. 2B illustrates an example of automated wheel removal and wheel replacement stations. This example illustrates a physical structure 220 with three bays 222, 224, 226. The physical structure 220 includes multiple robotic apparatus 250 (also referred to as 150 in FIG. 1), multiple control stations 258, multiple wheel holding stations 256, and multiple tire balancing machines 270. This example illustrates a configuration where multiple vehicles 210 may be serviced by the robotic apparatus 250 for automated wheel removal, tire change and wheel replacement.

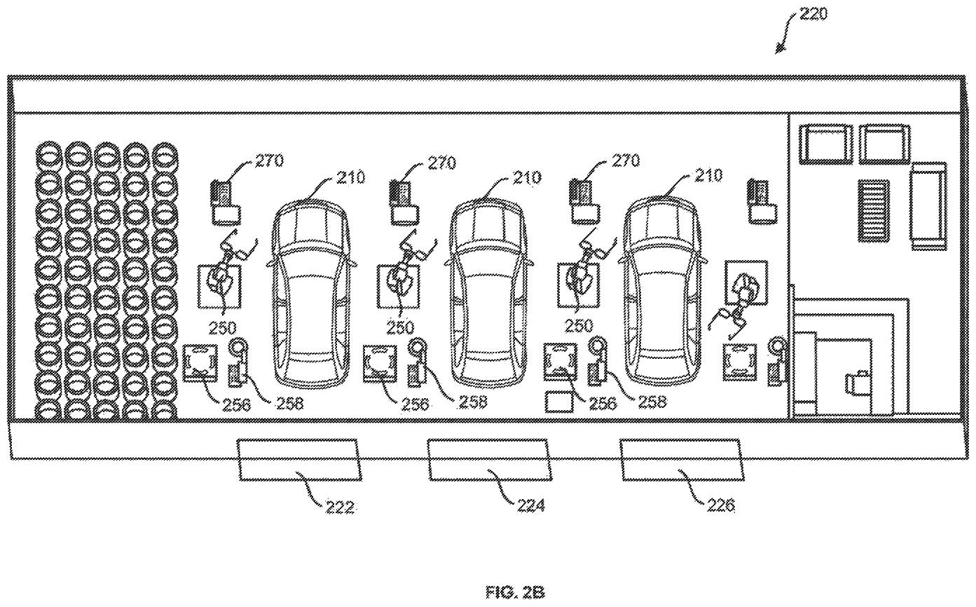

Referring to FIG. 3, an exemplary application user interface (300) of system 100 is disclosed. The application user interface 300 may be presented via a user computing device using a browser, other network resource viewer, desktop or mobile application, or otherwise. The user interface 300 includes a portion of the user interface 310 for obtaining vehicle information. The user interface 300 additionally includes a portion 320 for receiving a selection of a tire. The user interface 300 additionally includes a portion 330 for choosing a physical location for the changing of a tire. The user interface 300 additionally includes a portion 340 for selecting a date and time for scheduling the tire change job. The user interface 300 show available appointment dates and times.

System 100 obtains customer order information through a respective website or device application. (An application can herein be described by as a software program that runs on a computer or mobile device.) A user may interact with a device 102 (as depicted in FIG. 1) (e.g. phone, tablet, computer, etc.) that runs and thereby executes an application, for example that has been downloaded from an online application store. Via a user interface of system 100, a user can specify their vehicle make, model, and year 310.

System 100 may prompt the user for additional information, wherein the user selects and purchases a desired tire model(s) via the user interface 320. Additionally, system 100 prompts the user to input which tire(s) is/are going to be replaced. (i.e. the front driver's side tire, front passenger side tire, rear passenger side tire, etc.) System 100 stores information received from the user within the database 112.

System 100 prompts the user to input information about their desired appointment date and time 340. System 100 checks for available dates and store hours listed by the commercial location for appointment. Once identified, system 100 presents the appointment slots to the user in the respective device's interface.

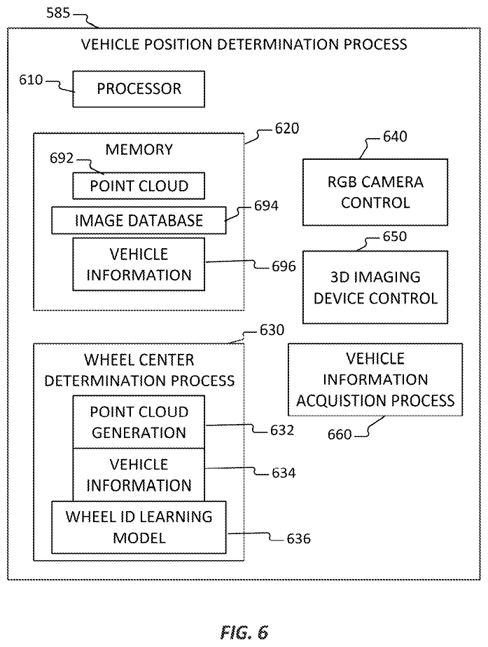

FIG. 6 illustrates an example table for a database 112 of system 100. This table 600 represents a table that includes information for automating vehicle lifting, vehicle wheel removal/replacement. For example, table 600 may include a unique vehicle identifier, the make of a vehicle, the model of the vehicle, the lug-nut configuration of the vehicle, a vehicle lift height, lifting points coordinates, axle distance.

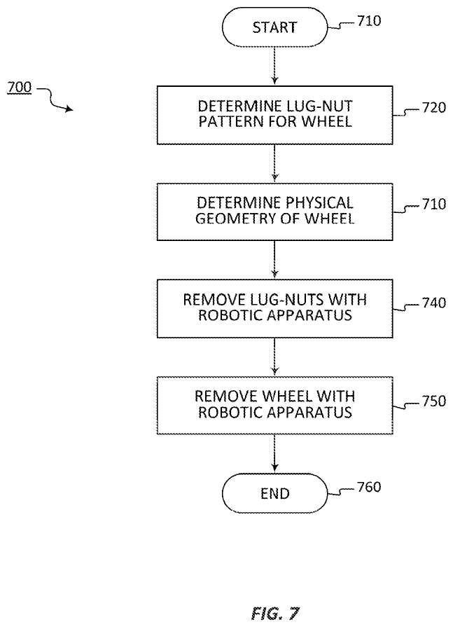

FIG. 7 illustrates various modules 740-760, or processes, that system 100 may perform. The modules 740-760 may be performed by any number of processors, and by any number of computers. The modules may be executed as software instructions, such as a daemon or service, by a computing device 710 by hardware processor 720. Executable instructions, programs or other code may be stored in a machine-readable storage medium 730.

### Lug-Nut and Wheel Removal

System 100 may include module 746 for performing operations of removing a wheel from a vehicle. FIG. 7 illustrates a method 700 for automated lug-nut and wheel removal. The method begins (block 710) with system 100 determining the lug-nut pattern for a wheel (block 720). System 100 determines the physical geometry of the wheel of a vehicle (block 730). System 100 then removes using a robotic apparatus the lug-nuts from the wheel (block 740). System 100 then removes the wheel from the vehicle (block 750). The method then ends (block 760).

Before, during or after lifting of the vehicle, system 100 may direct the robotic apparatus into a first wheel removal position. If the robotic apparatus is affixed to the ground, then the tooling head of the robotic apparatus is moved into a first wheel removal position. Setting the robotic apparatus, and/or the tooling head, to the first wheel removal position places the robotic apparatus in proximity to a wheel of the vehicle, thereby allowing the robotic apparatus to perform a wheel removal procedure.

System 100 may detect if the lug nuts have locks. System 100 may detect a pattern on the surface of a lug nut by analyzing an image and determining that the lug nut may have a lock. The particular lug nut lock pattern may be associated in the general vehicle database with a required robotic tool attachment. For removal of a locked lug nut, the robotic apparatus may have specialized keyed sockets that are used to remove the locked lug nut.

System 100 determines a lug-nut pattern for the wheel. The lug-nut pattern may be obtained from the database as associated to a particular year, make and model of the vehicle. System 100 may have stored in the database 112 associated dimensional information about the lug-nut pattern which system 100 uses to move one or more torque wrenches coupled to the robotic apparatus 150 for removal and replacement of lug nuts.

Additionally, the robotic apparatus 150 (i.e., system 100) may determine a physical geometry of the wheel as to the tooling head of the robotic apparatus. The robotic apparatus for example may have lasers or other types of sensors that the robotic apparatus 150 may use to determine distances, and/or proximity, of the robotic apparatus to a vehicle's wheel. The robotic apparatus 150 may determine a plane and/or orientation of the vehicle's wheel in a three-dimensional space. While distance sensors may be used, additionally an obtained 3-D point cloud from 3d capture devices (such as 3d cameras, LiDAR sensors, a stereo vision system for 3-dimensional depth perception, or using structured light, time of flight, or other suitable devices that may be used for generating a 3-D point cloud) may be used. Determining an orientation or plane of the wheel assists the robotic apparatus in determining proper alignment of a socket when being placed onto a lug nut. If the plane of the wheel is determined, then the robotic apparatus can move linearly in a perpendicular fashion toward the wheel. System 100 may then maintain the socket in a 90 degree orientation to the wheel as the socket is moved towards the wheel by the robotic apparatus 150.

Additionally, system 100 may determine a lug nut pattern via computer vision processing where a digital image of the wheel is obtained. System 100 processes obtained images using object detection techniques to identify lug nuts in the image of the wheel. System 100 can determine based on the number of lug nut objects detected, the type of lug nut pattern (i.e., 4, 5, 6 or 8-lug nut pattern, or other lug nut patterns). System 100 may also calculate the centroid of the lug nuts, and the spatial dimensions for each of the lug nuts.

System 100 may then use the determined lug-nut pattern, and/or the determined physical geometry of the wheel to maneuver the robotic apparatus tooling head from one location to another location to place one or more sockets onto a respective lug nut.

The robotic apparatus can dynamically adjust between removal of lug nuts for a 4-lug nut configuration, a 5-lug nut configuration, or a 6-lug nut configuration, or other lug nut configurations. This dynamic aspect of system 100 is quite different from an unchanging system that has a fixed-known configuration. Additionally, even within a particular lug nut configuration, for example a 5-lug nut pattern, the spacing of the lug nuts are variable among different vehicles.

System 100 addresses this variability by multiple means. For example, based on the particular vehicle information, the General Vehicle Database may store the type (4, 5, 6, or 8-lug nut pattern, or other lug nut patterns), and the dimensional spacing of the lug nuts. Once a first lug nut position is located on the wheel, then system 100 may calculate or determine the position of the remaining lug nuts of the wheel and maneuver the robotic arm accordingly.

### Socket Selection

The robotic apparatus 150 may use or be fitted with one or more sockets for the removal of lug nuts. The sockets may be detachably affixed to a torque wrench end of the robotic apparatus 150. System 100 may determine a socket size to be used to remove a lug nut from a wheel. The determination of the size of a lug nut may be performed through a computer vision process where an image of a wheel is obtained, and the system processes the image, and detects a size of the lug nut. Based on the determined size of the lug nut, system 100 would instruct the robotic apparatus 150 to pick the appropriate socket size for the lug nut.

As discussed previously, a user of the system may input their vehicle information for a tire change job. Based on the vehicle information, such as make, model, and year, system 100 may have stored for retrieval in the database 112, such as the general vehicle database, a particular socket size that is typically used for the particular vehicle associated with the vehicle information. When removing a lug nut, system 100 may search for a stored data value for a socket size to be used, and then system 100 may direct the robotic apparatus 150 to select or use a socket based on the data value for the socket size.

The robotic apparatus 150 may select or be fitted with different socket sizes. In one example, the robotic apparatus chooses from 6 different socket sizes, 3 metric sizes (17 mm, 19 mm, 21 mm) and 3 standard size (¾″, 13/16″, ⅞″). Additionally, based on the vehicle information, system 100 may choose from the group of 3 metric sockets, or choose from the group of 3 standard size sockets for removal of the vehicle's lug nuts.

Sometimes a socket may have been selected that is either too large, or too small, for the lug nut. System 100 may detect this error condition. When the error condition is determined, then the robotic apparatus may pull the robotic arm back away from the lug nut. A smaller or larger socket size may be chosen by the robotic apparatus.

When a socket has been positioned onto a lug nut, the socket begins rotation in a counterclockwise manner to remove the lug nut. The robotic apparatus may include a torque sensor to receive a value for the torque applied to the lug nut. The torque value may be monitored by system 100 to determine if the value remains within a threshold torque range. If the torque exceeds this value, then possibly the lug nut is frozen onto the wheel hub bolt. The robotic apparatus 150 may cease rotation of the socket and the wheel vehicle operation if this occurs. System 100 may generate an exception message via a user interface for review by an operator.

In one embodiment, the robotic apparatus 150 includes a mechanism for insertion into the lug nut holes of the wheel. For example, the robotic apparatus 150 inserts one or more longitudinal fingers into the holes of the wheel where the lug nuts were removed. The robotic apparatus 150 may place the longitudinal fingers into the lug nut holes and then either move the fingers outwardly toward the tire and/or inwardly toward the center of the wheel, or in some other direction, to seat or mate the longitudinal fingers against the interior surface of the lug nut holes of the wheel. The longitudinal fingers may be coated, or made from a rubber, plastic or other material that avoids damage to the wheel. Once the longitudinal fingers are seated, then system 100 directs the robotic apparatus 150 to pull the wheel away from the wheel hub of the vehicle.

In another embodiment to remove the wheel from the vehicle, the robotic apparatus 150 includes a tire gripper to hold the tire while the lug nuts are removed. The tire grippers are maneuvered by the robotic apparatus as controlled by system 100 into a position where gripping arms may contact a tire, for example the tread of the tire. The robotic apparatus 150 may use sensors, such as a computer vision system, to detect the perimeter of the tire, and guide the gripping arms onto the tire. System 100 may determine a width value of the tire, and place the gripping arms at locations around the tread portion of the tire to grip the tire at the maximum width of the tire.

Once the lug nuts are removed, then the robotic apparatus 150 pulls the wheel from the vehicle wheel hub. The robotic apparatus 150 may include bolt guides that are positioned onto one or more bolts by the robotic apparatus 150. Since system 100 has already identified the physical location of the lug nuts, after the lug nuts are removed, the robotic apparatus 150 may place a guide or sleeve over a bolt. The guide or sleeve may help carry the weight of the wheel and avoid direct contact (and damage) to a bolt.

After removing a first wheel, the robotic apparatus then proceeds to a second position to remove a second wheel. The robotic apparatus may be directed to move to a specified distance based on retrieved data specifying a distance value, the data being retrieved from the database 112. For example, the general vehicle database may store a value for the axle distance between a front and rear axle of a vehicle. System 100 retrieves this information and maneuvers the robotic apparatus 150 a linear distance according to the axle distance between the front and rear axle. This allows the robotic apparatus 150 to move to the location of the next wheel on the same side of the vehicle.

### Robotic Apparatus

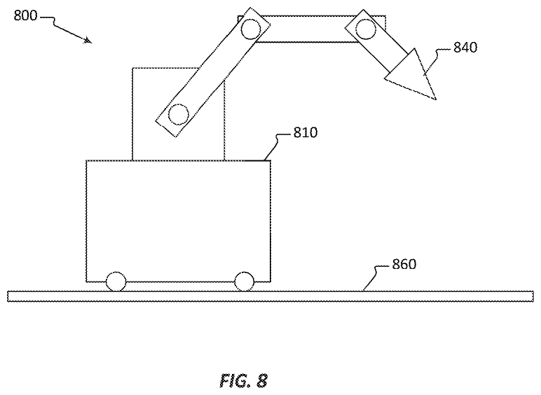

Referring to FIG. 8, an exemplary robotic apparatus 800 for wheel removal and replacement is disclosed. The robotic apparatus is generally referred to in FIG. 1 as 150. The robotic apparatus 800 is in electronic communication with system 100. The robotic apparatus 800 may receive instructions, commands and data from system 100. Likewise, the robotic apparatus may send data, and other information to system 100.

In some embodiments, the robotic apparatus has control circuitry, processors, and data storage. While the disclosure discusses operable communication with system 100, the robotic apparatus may perform the methods described herein without interaction with system 100.

The robotic apparatus may include different types of sensors for the inspection of a vehicle's wheel, these may include proximity sensors, video or still image cameras, LiDAR, thermal sensors, lighting, pressure sensors, and any combination thereof. For example, the sensors may obtain image information for a wheel, and system 100 may analyze the image to determine orientation of the lug nuts, to determine physical geometry of the wheel, and to determine other aspects of the wheel.

In one example, the robotic apparatus 800 is a 6-axis robot, or articulated robot, that allows articulated and interpolated movement to any point within a working envelope. At axis 1, the robot rotates the base 810 of the robot. At axis 2, the robot extends forward and backward the robot's lower arm. At axis 3, the robot raises and lowers the robot's upper arm. At axis 4, the robot's upper arm can wrist roll. At axis 5, the robot's lowers wrist of the robot's arm. At axis 6, the robot rotates wrist of the arm. The arm may have a tooling end 840 with sensors, a torque wrench, and/or other devices attached.

The robotic apparatus 150 may include proximity sensors to detect objects within a working envelope, or within a threshold distance, of the robotic apparatus 150. The working envelope is a physical volume of space of movement and/or operation of the robotic apparatus 150. For example, a sensor may detect movement of a person that walks near or into the working envelope of the robotic apparatus 150. System 100 may determine that the detected object is with a certain distance of the robotic apparatus 150. If the detected object is determined to be within a threshold distance of the robotic apparatus or the working envelope, then system 100 may direct the robotic apparatus to cease movement and/or other operations. System 100 may generate an error condition, and display the error condition to a user interface of system 100. In one example, the robotic apparatus 150 may automatically resume operation once system 100 determines that the detected object is no longer within the working envelope, or the within the threshold distance of the robotic apparatus 150. In another example, to resume operations, the user interface receives an input to resume operations. In response to the received input, the robotic apparatus 150 resumes operation.

Additionally, proximity sensors may be placed in a working environment, such as a vehicle bay, and the proximity sensors are communicatively coupled to system 100. Similar to the discussion above, system 100 may receive sensor data from the proximity sensors and detect an object within a working space, system 100 may in response to detecting the object, cause one or more robotic apparatus 150 to cease operations when the object moves into the working environment.

### Computer Vision

System 100 may include a computer vision module (756 as referenced in FIG. 7) that processes obtained images. As described herein, various components may use computer vision cameras or other sensors to assist in the location determination of physical aspects of the vehicle, physical geometry of physical aspects of the wheels of the vehicles.

Examples of image capture systems that may obtain an image via a computer vision camera and lug-pattern determination are described in PCT Application No. PCT/US2020/055441, filed Oct. 13, 2020. System 100 may determine the pattern of lug nut bolts, where there is a determined four bolt pattern, a five bolt pattern, a six bolt pattern and/or an eight bolt pattern.

System 100 may use a trained neural network to identify a lug nut pattern. For example, using machine learning training techniques, system 100 may be trained with multiple images of a 4-pattern, 5-pattern, 6-pattern, or 8 pattern lug nut configurations. Using the trained model in a production mode, then system 100 may identify a lug nut pattern from a received image as an input to the trained neural network.

In one embodiment, system 100 obtains an image of a wheel. System 100 may process the obtained image via the trained neural network as a data input, and an image classifier may then determine the particular lug nut pattern type. System 100 may then use the lug nut pattern type as discussed herein.

System 100 may also use an image object detection process to identify the number of lug nuts of the wheel. For example, system 100 may receive an image and detect the number of lug nut objects of a wheel depicted in the image. The system may identify the number of lug nuts, and set the lug nut pattern based on the number of lug nuts detected. For example, if system 100 detects 4 lug nut objects in the image, then system 100 may use a 4 lug nut pattern for lug nut removal for a wheel. If system 100 detects a 5 lug nut objects in the image, then system 100 may use a 5 lug nut pattern for lug nut removal for a wheel. Based on the position of the detected objects, the system may calculate a centroid or center of the objects by connecting a line between each of the lug nut objects, and determining an intersection point of the lines. The determined centroid of the wheel may be used to position the robotic apparatus for removal of the lug nuts from the wheel.

Additionally, fiducial markers may be placed on the vehicle to assist system 100 for determining locations. As an example, stickers with certain patterns, colors, shapes, or a combination thereof, may be placed on the vehicle. In the context of the vehicle lifting process, these fiducial markers may be placed on lifting points under the vehicle which would assist the vehicle lifting device in locating the lifting contact points for the vehicle.

Additionally, fiducial markers may be placed on a wheel fastener to indicate a location of a lug nut. This may help the robotic apparatus 150 in determining one or more positions of lug nuts of the vehicle. Fiducial markers may be wireless devices that may be affixed to the vehicle. The wireless device may be for example a blue-tooth enabled socket that is placed onto the lug nut. The socket size of the blue-tooth enabled socket may be for example in the sizes of (SAE ¾ inch, ⅞ inch, 13/16 inch; Metric 17 mm, 19 mm, 21 mm). Each of the wireless devices may emit a unique signal or signature that may be recognized by system 100. Using multiple fiducial markers on the lug nuts system 100 may determine the lug nut configuration of the wheel. System 100 may detect the position of fiducial markers placed adjacently to one another, or placed across from one another, or placed on the second or third lug nut. System 100 may then determine the center or centroid of two markers and calculate the distance between the markers. Additionally, system 100 may determine the angle of two lines from a first fiducial marker and to a second fiducial marker, and then from the second fiducial marker to a third fiducial marker that have been placed on the lug nuts.

Based on the position of the lug nuts the system may determine the bolt pattern (for example the number of bolts and metric size in mm and/or imperial size in inches: 4-100, 4×3.94; 4-114.3, 4×4.5; 5-100, 5×3.94; 5-108, 5×4.25; 5-112, 5×4.41; 5-114.3, 5×4.5; 5-115, 5×4.52; 5-12, 5×4.72; 5-120.7, 5×4.75; 5-127, 5×5; 5-130, 5×5.12; 5-135, 5×5.3; 5-139.7, 5×5.5; 6-114.3, 6×4.5; 6-127, 6×5; 6-135, 6×5.3; 6-139.7, 6×5.5; 8-165.1, 8×6.5; 8-170, 8×6.69. The first number indicates how many lug nuts are on the wheel, and the second number describes the distance between two lug nuts. This is also referred to as the bold circle diameter, or the pitch circle diameter. While the foregoing discusses system 100 using fiducial markers to determine a bolt pattern, system 100 may also determine the bolt pattern using computer vision by obtaining imagery of the bolts on the wheel and using an object detection process to identify the centroid, or edge of the lug nuts. The number of bolts and the metric size in mm and/or imperial size may then be calculated by system 100.

The system using computer vision, fiducial makers, or other techniques described herein may determine the particular bolt pattern for the vehicle. System 100 may then instruct the robotic apparatus accordingly to remove and/or replace lug nuts. In determining the particular size of the bolt pattern in the case of a vehicle with four lug nuts, system 100 may measure the center of two holes that are directly across from one another. In determining the particular size of the bolt pattern in the case of a vehicle with five lug nuts, system 100 may measure from the center on one lug nut to the back of the third lug nut. In determining the particular size of the bolt pattern in the case of a vehicle with six lug nuts, system 100 may measure the center of two holes that are directly across from one another. In determining the particular size of the bolt pattern in the case of a vehicle with eight lug nuts, system 100 may measure the center of two holes that are directly across from one another.

### Positioning and Movement of Robotic Apparatus

Examples of robotic apparatus for wheel replacement and removal, and methods of controlling the robotic apparatus, are disclosed in PCT Application No. PCT/US2020/055441, filed Oct. 13, 2020.

Due to the variability of the length of a vehicle, system 100 may automatically position one or more robotic apparatus based on the wheelbase dimension of a vehicle. For example, a truck would have a longer wheel-base than a sedan. As discussed previously, the wheelbase of a vehicle may be determined by system 100 receiving information (e.g., scanning the VIN, scanning the license plate, from the customer's input during scheduling or can be manually entered and received by system 100 via a user interface), and/or using a vision system (e.g., a system connected digital camera) to obtain digital imagery of two wheels on one side of the vehicle. Using the computer vision system, system 100 may then determine a distance from a centroid of the first wheel (e.g., the front wheel) and a centroid of a second wheel (e.g., the rear wheel). To establish an accurate distance, a known fixed device may be included in the imagery. For example, a fixed length object, a magnetic device, such as a ruler, or other marker, may be placed onto or adjacent to the body of the vehicle where the digital camera would be able to capture the device in an image. System 100 may have previously stored dimensions of the known fixed or magnetic device. Using the dimensions of the device or marker, system 100 may then determine an accurate ratio of the device or marker, and the centroids of the first and second wheels to establish an accurate wheelbase measurement. System 100 may then save the wheelbase measurement in a memory store associated with the vehicle being serviced.

In one embodiment, system 100 may direct linear movement of the robotic apparatus along a rail based on a wheelbase associated with the vehicle. For example, after the robotic apparatus has been positioned to the first wheel for service operations (e.g., lug nut removal and/or replacement), system 100 may instruct the robotic apparatus to linearly move along a rail based on the wheelbase associated with the vehicle to the second wheel for service.

### Machine Learning of Lug Nut Locks, Lug Nuts and Lug Nut Patterns

System 100 may train a machine learning model to identify, classify and/or infer from a digital image of a vehicle wheel the type of lug nut pattern, the type of lug nut (i.e., generally referred to as a wheel fastener) and/or the type of lug nut lock. System 100 may use any suitable machine learning training technique, including, but are not limited to a neural net based algorithm, such as Artificial Neural Network, Deep Learning; a robust linear regression algorithm, such as Random Sample Consensus, Huber Regression, or Theil-Sen Estimator; a kernel based approach like a Support Vector Machine and Kernel Ridge Regression; a a tree-based algorithm, such as Classification and Regression Tree, Random Forest, Extra Tree, Gradient Boost Machine, or Alternating Model Tree; Naïve Bayes Classifier; and others suitable machine learning algorithms.

System 100 may be trained with a training sample of multiple images of lug nut locks. Using the trained model in a production mode, then system 100 may identify a lug nut type on a wheel a received image as an input to the trained neural network. In response to determining the type of lug nut lock, system 100 may indicate a required socket needed to remove the type of lug nut lock. System 100 may automatically retrieve or obtain the required socket for the tooling end of the robotic apparatus.

System 100 may be trained with a training sample of multiple images of lug nuts. Using the trained model in a production mode, then system 100 may identify a lug nut type on a wheel a received image as an input to the trained neural network. In response to determining the type of lug nut, system 100 may indicate a required socket needed to remove the type of lug nut. System 100 may automatically retrieve or obtain the required socket for the tooling end of the robotic apparatus.

System 100 may be trained with a training sample of multiple images of a 4-pattern, 5-pattern, 6-pattern, or 8 pattern lug nut configurations. Using the trained model in a production mode, then system 100 may identify a lug nut pattern on a vehicle wheel from a received image as an input to the trained neural network. In response to determining the type of lug nut pattern for the vehicle wheel, system 100 may instruct a robotic apparatus tooling end to maneuver to positions in accordance of the pattern to remove and/or replace lug nuts of a vehicle wheel.

In one embodiment, system 100 may be trained with a training sample of digital images depicting lug nuts having a lug nut lock. To remove a lug nut having a lug nut lock, a particular lug nut key socket is required to remove the lug nut having the lug nut lock. System 100 may obtain a digital image of the lug nuts of a wheel of a vehicle. System 100 may use a trained machine learning model to determine the probability or likelihood that a particular lug nut is of a lug nut lock type. System 100 may train the machine learning model to identify a particular lug nut lock pattern. For example, each of the lug nut key sockets have a different key pattern to remove a particular type of lug nut lock. System 100 may determine that a key pattern of a lug nut is of a particular type and/or shape. Based on the identified type or shape of the lug nut key pattern, system 100 may identify a particular lug nut key socket that would be required to remove the lug nut having a lug nut lock. For example, system 100 may determine from an obtained image of a wheel of a vehicle that a lug nut has a lug nut key pattern. Determination of the lug nut key pattern would indicate to system 100 that a lug nut key socket will be required to remove the lug nut having the lug nut key.

System 100 may determine which particular lug nut key socket should be used to remove the lug nut having the lug nut lock. For example, based on the key pattern shape, system 100 may identify which particular lug nut key socket corresponds to the key pattern shape. System 100 may then indicate, via a user interface of system 100, the particular key socket that is needed to remove the lug nut lock. In this case, an operator would retrieve the appropriate key socket and place the key socket on the torque wrench affixed to the tooling end of a robotic apparatus. Also, system 100 may optionally be configured to allow the tooling end of the robotic apparatus to automatically retrieve from a set of key sockets and obtain the particular key socket needed to remove the lug nut lock. In one embodiment, an operator may simply place the correct key socket onto the lug nut lock of the wheel, and system 100 will detect the placed key socket, and automatically couple the torque wrench with the key socket.

After obtaining the particular key socket needed to remove the lug nut lock, then system 100 instructs the robotic apparatus to remove the lug nut lock from the wheel hub of the wheel. For example, system 100 may direct the tooling end of the robotic apparatus equipped with a torque wrench and obtained particular key socket to remove the lug nut lock.

After system 100 has obtained the image of the wheel depicting the lug nuts and determined the occurrence of a lug nut lock, system 100 may store in non-volatile storage (such as a database) a physical position of the lug nut lock on the wheel. For example, system 100 may store the location of the lug nut lock as a coordinate (or set of coordinates) for a 3-dimensional space map. System 100 may maneuver the lug nut key socket to the stored position of where the lug nut lock is located on the wheel.

In combination with the stored lug nut lock position, or independently, system 100 may also use computer-assisted vision to place of the lug nut key socket on the lug nut lock. For example, the tooling end of the robotic apparatus may have an attached camera. System 100 may obtain a continuous stream of digital images. As described above, system 100 may detect the occurrence of the lug nut lock based on object detection, machine learning inference, or other suitable computer-vision technique. System 100 then may maneuver the lug nut key socket to the location of the lug nut lock on the vehicle wheel.

Once positioned in front of the lug nut lock, system 100 instructs the robotic apparatus to move the tooling end of the linearly towards the lug nut key lock, such that the lug nut key socket sets over the lug nut lock. To position over key pattern of the lug nut lock, system 100 may instruct the robotic apparatus via the torque wrench to slowly rotate the lug nut key socket such that the inner key pattern of lug nut key mates or matches up with the key pattern of the lug nut lock. To confirm proper placement of the lug nut key socket on the lug nut lock, system 100 may direct the torque wrench to rotate the lug nut key socket while applying a force against the lug nut. System 100 may obtain via feedback from the torque wrench a resistance (or torque) value. Should the resistance (or torque) meet or exceed a predetermined threshold value, system 100 may confirm that the key portion of the lug nut key socket is properly set within the lock portion of the lug nut lock. System 100 may then add increasing levels of torque against the lug nut lock to commence rotation (such as counter-clockwise rotation) of the lug nut lock. System 100 would continue to rotate the lug nut lock until the lug nut lock is removed.

Methods for machine learning training and inference of lug nut types based on digital imagery are described in PCT Application No. PCT/US2020/055441, filed Oct. 13, 2020. System 100 may be trained with a training sample of digital images depicting lug nuts having differing shapes and sizes. To remove a lug nut from a wheel, a particular sized and internal shape of lug nut socket is required to remove the lug nut.

System 100 may obtain a digital image of the lug nuts of a wheel of a vehicle. System 100 may determine for a lug nut of the wheel the size and shape of the lug nut. System 100 may use a trained machine learning model to determine the probability or likelihood that a particular lug nut is of a particular size and shape. Also, system 100 may employ shape detection determination to identify the shape and size of the lug nut. Based on the determined shape and size of the lug nut, system 100 may identify that a particular lug nut requires a particular sized and shape lug nut socket.

System 100 may obtain a socket for the required shape and size of the lug nut. System 100 may indicate, via a user interface of system 100, that a particular socket is needed. In this case, an operator would retrieve the appropriate socket and place the socket on the torque wrench affixed to the tooling end of a robotic apparatus. Also, system 100 may optionally be configured to allow the tooling end of the robotic apparatus to automatically retrieve from a set of sockets and obtain the particular socket needed to remove the lug nut. In one embodiment, an operator may simply place a correctly sized socket onto a lug nut, and system 100 will detect the placed socket, and automatically couple the torque wrench with the socket.

After obtaining the particular socket needed to remove the lug nut, then system 100 instructs the robotic apparatus to remove the lug nut from the wheel hub of the wheel. For example, system 100 may direct the tooling end of the robotic apparatus equipped with a torque wrench and the obtained particular socket to remove the lug nut.

After system 100 obtained the image of the wheel depicting the lug nuts, system 100 may also store in non-volatile memory (such as a database) a physical position of the one or more lug nuts. For example, system 100 may store the location of the one or more lug nuts as a coordinate (or set of coordinates) for a 3-dimensional space map. System 100 may maneuver the lug nut socket to each of the stored positions where lug nuts of the vehicle wheel are located.

In combination with the stored lug nut position, or independently, system 100 may also use computer-assisted vision to place of the lug nut socket onto a lug nut. For example, the tooling end of the robotic apparatus may have an attached camera. System 100 may obtain a continuous stream of digital images. As described above, system 100 may detect the occurrence of a lug nut based on object detection, machine learning inference, or other suitable computer-vision assisted technique. System 100 then may maneuver the lug nut socket to a location of a lug nut on the vehicle wheel.

Once positioned in front of a lug nut, system 100 instructs the robotic apparatus to move the tooling end linearly towards the lug nut, such that the lug nut socket sets over the lug nut. System 100 may need to slowly rotate the socket such that the internal socket edges align with the lug nut edges. To confirm proper placement of the lug nut socket on the lug nut, system 100 directs the torque wrench to rotate the lug nut socket. System 100 may obtain feedback from the torque wrench indicating a resistance (or torque) value. Should the resistance (or torque) value meet or exceed a predetermined threshold value, system 100 may confirm that the lug nut socket is properly set. System 100 may increase the level of torque of the torque wrench to then commence rotation (such as counter-clockwise rotation) of the lug nut socket to remove the lug nut. System 100 would continue to rotate the lug nut socket until the lug nut is removed.

Typically, a vehicle will have a similar lug nuts on each of the four wheels of a vehicle. In the instance of the robotic apparatus having the correct lug socket attached to the torque wrench, after removing a lug nut of a first wheel (e.g. a front wheel) of a vehicle, system 100 may direct the robotic apparatus to position to another location such that the robotic apparatus 150, 250, 800 may be able to remove each of the lug nuts of a second wheel (e.g., a back wheel) of the vehicle.

Methods for machine learning training and inference of lug nut patterns based on digital imagery are described in PCT Application No. PCT/US2020/055441, filed Oct. 13, 2020. System 100 may be trained with a training sample of digital images depicting lug nuts having differing patterns (e.g., a four bolt pattern, a five bolt pattern, a six bolt pattern and/or an eight bolt pattern). To remove the lug nuts from a wheel, system 100 needs to identify the location of each of the lug nuts to be removed.

System 100 may obtain a digital image of the lug nuts of a wheel of a vehicle. System 100 may determine for a lug nut pattern of the lug nuts depicted in the image. System 100 may use a trained machine learning model to determine the probability or likelihood that a lug nut pattern in the digital image is of a particular lug nut pattern type (e.g., a four bolt pattern, a five bolt pattern, a six bolt pattern and/or an eight bolt pattern).

System 100 then performs upon a first vehicle wheel lug nut removal by the robotic apparatus based on the determined lug nut pattern. System 100 then may determine based on the pattern of the lug nuts, the locations and distances the tooling end (e.g. with attached torque wrench and/or socket) needs to move from one lug nut to the next. Additionally, system 100 may determine a lug nut loosening and/or replacement sequence of the lug nuts, and a path for the tooling end of the robotic apparatus to move from one lug nut to the next. For example, based on a four lug nut pattern, with lug nut referenced as 1, 2, 3 4 sequentially from a first lug nut to the next lug nut in a clock-wise manner, system 100 may determine that for the four lug nut pattern, that lug nut 1, then lug nut 3, then lug nut 2, and then lug nut 4 should be loosened in that order to optimally remove the lug nuts. For a five lug nut pattern referenced as 1, 2, 3, 4, 5 sequentially from a first lug nut to the next lug nut in a clock-wise manner, system 100 may determine that for the five lug nut pattern, that lug nut 1, then lug nut 3, then lug nut 5, then lug nut 2, and then lug nut 4 should be loosed in that order to optimally remove the lug nuts from the wheel studs. For the six and eight lug nut pattern, system 100 may also use a predetermined path or sequence base on the lug nut pattern type to remove and/or replace the lug nuts.

Since system 100 has determined the lug nut pattern for a first vehicle wheel, system 100 may forgo determining the lug nut pattern for subsequent wheels of a vehicle. System 100 may after performing a lug nut replacement and/or removal operation on a first wheel, may direct the robotic apparatus to maneuver to the location of a second wheel. System 100 may then perform upon the second vehicle wheel lug nut removal and/or replacement by the robotic apparatus based on the previously determined lug nut pattern.

Moreover, while a lug nut is being applied to the wheel stud, system 100 may determine how far the lug nut has moved along the length of the wheel stud. Initially, when system 100 removes a lug nut from the wheel stud, system 100 may track the number of rotations of the lug nut from an original seated position against a wheel to a free position. The free position is when the lug nut detaches from the wheel stud. System 100 may compute a distance the lug nut has moved based on the number of rotations of the lug nut.

Additionally, system 100 may measure the linear distance the tooling end of a robotic apparatus moves to rotate a lug nut from a seated position to a free position. System 100 may store the linear distance that each lug nut traveled from the seated position to the freed position. For a particular wheel of a vehicle, system 100 may track the distances each of the lug nuts have traveled. Then when system 100 replaces a lug nut to a respective wheel stud, system 100 may track the distance the lug nut has traveled back on to the wheel stud. While the foregoing refers to a lug nut and wheel stud, the measuring also applies to a wheel bolt which are screwed into a threaded hole in a wheel hub, commonly referred to as a bolted joint.

When reapplying the lug nut to a wheel stud, system 100 may determine the overall distance the lug nut has moved and stop rotation when the lug nut has moved to an approximate distance similar to the measured distance when the lug nut was removed.

Moreover, when reapplying a lug nut to a wheel stud, system 100 may determine whether the lug nut is fully seated against the wheel of the vehicle. System 100 may use an initial determined position where the robotic apparatus removed the lug nut. As described above, system 100 may determine the distance of how far a lug nut (or a wheel bolt) has traveled from an original seated position against the wheel. System 100 may also confirm that a lug nut is seated against the wheel via computer vision image acquisition and analysis. For example, system 100 may obtain digital imagery of the lug nut while the lug nut is being applied and fastened to the wheel stud. System 100 may evaluate the obtained digital imagery to determine whether any threads are exposed. If system 100 determines that threads are still exposed, then system 100 may infer that the lug nut is not yet seated. Moreover, system 100 may evaluate whether there exists any gap between the end of the lug nut and the wheel. A detection of a gap by system 100 would indicate that the lug nut is not fully seated against the wheel. Additionally, system 100 may use a laser measuring device to measure a distance to a surface of the pocket of the wheel rim and the lug nut. If the measured distance exceeds a predetermined threshold distance value, then they system 100 may determine that the lug not is not yet fully seated. If system 100 determines that the lug nut is not fully seated, system 100 may instruct the robotic apparatus to apply additional rotational torque to the lug nut, and then stop rotational torque when a predetermined torque value has been achieved.

Also, system 100 may stop rotation of the lug nut when the lug nut reaches a specified torque value (e.g., 20-120 ft-lbs.) or when the lug nut is within a torque value range. For example, system 100, when replacing a lug nut, may determine that the lug nut is fully seated against the wheel and then continue rotation of the lug nut until a predetermined torque value has been reached. System 100 may retrieve a torque value from a database with stored torque values for different vehicle makes and models. Based on a retrieved torque value from the database, system 100 may instruct the robotic apparatus to tighten the lug nut to the retrieved torque value for the specified make and model of vehicle. Additionally, system 100 may provide a system user interface where an operator may input a desired torque value for a vehicle. System 100 will then instruct the robotic apparatus to torque one or more lug nuts of a vehicle to the specified input data value. The foregoing also apples to a wheel bolt as to the threaded hole. Once system 100 has determined that the lug nut is fully seated, system 100 may instruct the robotic apparatus to replace the lug nut for another wheel stud

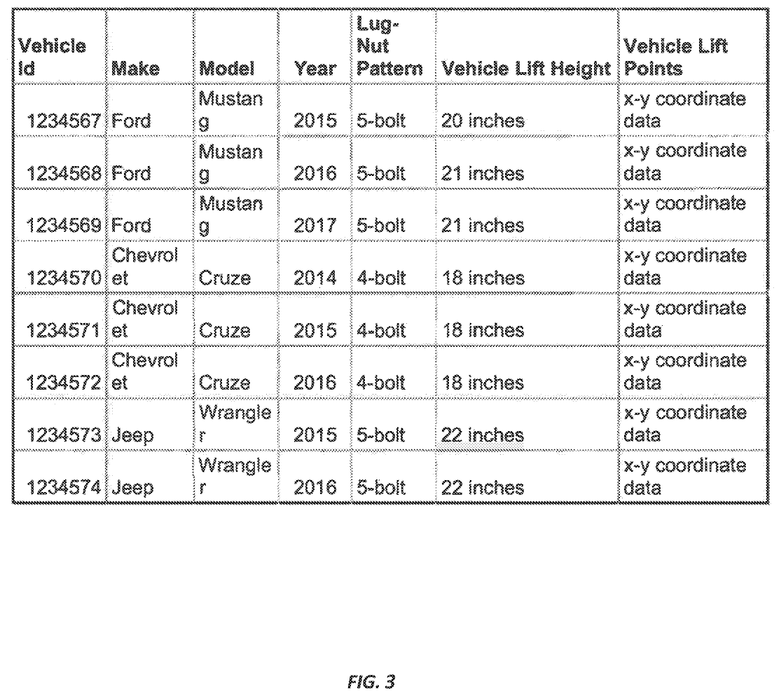

FIG. 4 shows a communication network in accordance with an embodiment. Communication network 400 includes a network 405, a vehicle maintenance manager 435, a database 450, and a robotic apparatus system 475.

In one embodiment, components of communications network 400 are located and operate within a vehicle maintenance facility such as an automobile repair shop, a tire change store, or other similar establishment. Components of communications network 400 may be activated, for example, when a vehicle enters a vehicle bay in the facility.

Network 405 may include any type of network adapted to transmit data. Network 405 may include, for example, a local area network (LAN), a virtual LAN (VLAN), a wireless local area network (WLAN), a virtual private network (VPN), cellular network, wireless network, the Internet, or the like, or a combination thereof. In one embodiment, network 405 includes computer network 126.

Vehicle maintenance manager 435 manages the performance of various vehicle maintenance-related tasks. For example, in response to a request to perform a specified maintenance task, vehicle maintenance manager 435 may instruct robotic apparatus system 475 to perform the specified task.

In one embodiment, vehicle maintenance manager 435 may include software and/or hardware residing and operating on computer 102. Database 450 may be a privately maintained database or may be a publicly available information source. For example, vehicle maintenance manager 435 may be part of a software application (or group of software applications) that schedules and manages vehicle maintenance tasks.

Vehicle maintenance manager 435 and/or robotic apparatus system 475 may from time-to-time access database 450 to obtain information relating to vehicles, wheels, lug-nuts, etc. For example, vehicle maintenance manager 435 and/or robotic apparatus system 475 may access database 450 to obtain information specifying various aspects of a particular vehicle including dimensions of the vehicle, locations of various components of the vehicle, types of tires that may be used on the vehicle, etc.

Database 450 is adapted to store data relating to vehicles, wheels, lug-nuts, etc. For example, database 450 may include the General Vehicle Database described above.

Robotic apparatus system 475 is adapted to perform various vehicle maintenance tasks. In order to facilitate performance of these tasks, robotic apparatus system 475 is adapted to obtain information pertaining to a vehicle's position in the vehicle bay. For example, robotic apparatus system 475 may generate one or more images of the vehicle and analyze the images to determine a vehicle's position within the vehicle bay with a desired degree of precision. Robotic apparatus system 475 may be from time to time move a vehicle, or cause a vehicle to move, within the vehicle bay to a desired position. Robotic apparatus system 475 may additionally be adapted to perform one or more vehicle maintenance tasks, such as removing lug nuts from a wheel, removing and replacing a wheel, etc.

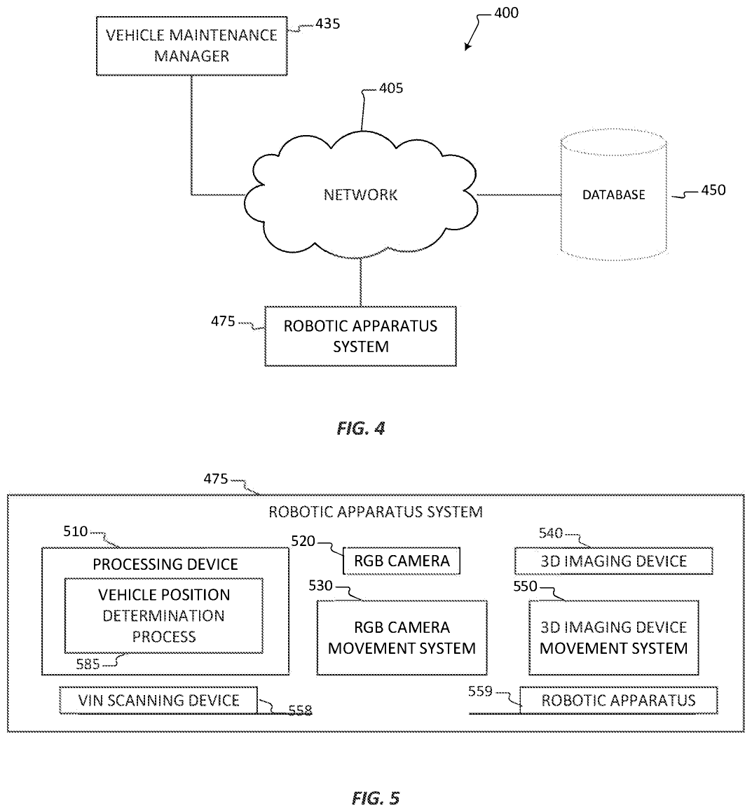

FIG. 5 shows components of robotic apparatus system 475 in accordance with an embodiment. Robotic apparatus system 475 includes a processing device 510, an RGB camera 520, an RGB camera movement system 530, a 3D imaging device 540, a 3D imaging device movement system 550, a vehicle identification number (VIN) scanning device 558, and a robotic apparatus 559.

RGB camera 520 is adapted to obtain images of a selected object or field of view. For example, RGB camera 520 may from time to time obtain an image of a wheel or other portion of a vehicle. Images obtained by RGB camera 520 are stored in image database 694 (shown in FIG. 6).

RGB camera movement system 530 includes an apparatus adapted to support RGB camera 520 and move RGB camera 520 in three-dimensions to a desired position. For example, RGB camera movement system 530 may from time to time move RGB camera 520 to a selected position that allows RGB camera 520 to obtain an image of a wheel of a vehicle. RGB camera movement system 530 may include support structures, mechanical arms, tracks, rails, wheels, gears, and/or any other structures or devices suitable for supporting and moving RGB camera 520. RGB camera movement system 530 is also adapted to rotate RGB camera 520 with respect to multiple axes in order to position the camera with a desired orientation.

3D imaging device 540 is adapted to obtain 3-dimensional images. For example, 3D imaging device 540 may from time to time obtain a 3D image of a particular wheel of a vehicle. 3D imaging device 540 may include such as 3d cameras, LiDAR sensors, a stereo vision system for 3-dimensional depth perception, or using structured light, time of flight, or other suitable devices that may be used for generating a 3-D point cloud. 3D image data obtained by 3D imaging device 540 is provided to point cloud generation 2232 (shown in FIG. 5).

3D imaging device movement system 550 includes an apparatus adapted to support 3D imaging device 540 and move 3D imaging device 540 in three-dimensions to a desired position. For example, 3D imaging device movement system 550 may from time to time move 3D imaging device 540 to a selected position that allows 3D imaging device 540 to obtain a 3D image of a wheel of a vehicle. 3D imaging device movement system 550 may include support structures, mechanical arms, tracks, rails, wheels, gears, and/or any other structures or devices suitable for supporting and moving 3D imaging device 540. 3D imaging device movement system 550 is also adapted to rotate 3D imaging device 540 with respect to multiple axes in order to position the camera with a desired orientation.

VIN scanning device 558 is adapted to scan a vehicle's vehicle identification number from a predetermined location on the vehicle. For example, VIN scanning device 558 may scan a vehicle's VIN from the registration sticker attached to the vehicle's front windshield. VIN scanning device 558 may scan a vehicle's VIN from other locations on a vehicle. After scanning a vehicle's VIN, VIN scanning device 558 provides the VIN information to processing device 510.

Robotic apparatus 559 is a robotic apparatus adapted to perform a vehicle maintenance task. For example, robotic apparatus may include robotic apparatus 150, tire removal/replacement machines 160, tire balancing machine 170, etc.

Processing device 510 is adapted to control the operation of various components of robotic apparatus system 475. For example, processing device 510 controls the operation of RGB camera 520, and controls the movement of RGB camera 520 by controlling RGB camera movement system 530. Similarly, processing device 510 controls the operation of 3D imaging device 540, and controls the movement of 3D imaging device 540 by controlling 3D imaging device movement system 550. When a vehicle enters the vehicle bay, processing device 510 may instruct VIN scanning device 558 to scan a vehicle's VIN information.

When a vehicle enters the vehicle bay, robotic apparatus system 475 determines the position of the vehicle before performing any vehicle maintenance tasks. For this purpose, a vehicle position determination process 585, which may be, for example, a software application, resides and operates on processing device 510. Vehicle position determination process 585 is adapted to control various components of robotic apparatus system 475 in order to obtain information relating to the vehicle and determine the position of a vehicle in the vehicle bay. In the illustrative embodiment, vehicle position determination process 585 obtains images of the vehicle and then determines the location and position of one or more of the vehicle's wheels. Vehicle position determination process 585 also obtains information relating to the vehicle's dimensions. The vehicle's location and position are defined based on the location and position of the vehicle's wheel(s) and the vehicle's dimensions.

FIG. 6 shows components of vehicle position determination process 585 in accordance with an embodiment. Vehicle position determination process 585 includes a processor 2210, a memory 2220, a wheel center determination process 2230, an RGB camera control 2240, a 3D imaging device control 2250, and a vehicle information acquisition process 660.

Processor 610 controls the operation of various components of vehicle position determination process 585. Memory 620 is adapted to store data.

Wheel center determination process 630 is adapted to obtain information relating to a wheel of a vehicle and define a center of the wheel. Wheel center determination process 630 may analyze one or more images of a wheel and determine a location of a center of the wheel based on information in the image. Wheel center determination process 630 may use other types of information in addition to image data.

RGB camera control 640 controls the operation and movement of RGB camera 520. RGB camera control 640 from time to time causes RGB camera 520 to generate an image. RGB camera control 640 may cause RGB camera movement system 530 to move RGB camera 520 to a specified position to obtain an image of a vehicle, a wheel or a portion of a wheel. RGB camera control 640 may store images generated by RGB camera 520 in memory 620. In the illustrative embodiment of FIG. 6, images are stored in image database 694 in memory 620.

3D imaging device control 650 controls the operation and movement of 3D imaging device 540. 3D imaging device control 650 from to time causes 3D imaging device 540 to generate a 3D image. 3D imaging device control 650 may cause 3D imaging device movement system 550 to cause 3D imaging device 540 to move to a specified position to obtain an image of a vehicle, a wheel, or a portion of a wheel. 3D imaging device control 650 may store image data generated by 3D imaging device 540 in memory 620. For example, image data generated by imaging device 540 may be stored in image database 694 or in point cloud 692.

Vehicle information acquisition process 660 is adapted to control various components of vehicle position determination process 585 in order to obtain information relating to a vehicle, including dimension information, and to determine a position of the vehicle. Vehicle information acquisition process 660 is also adapted to use information obtained from various sources in order to define a reference point on the vehicle. The reference point may be used by to facilitate other processes, such as moving the vehicle within the vehicle bay and performing vehicle maintenance tasks.

Wheel center determination process 630 includes a point cloud generation 632, a wheel identification learning model 634, and a lug-nut identification learning model 636.

Point cloud generation 632 generates a point cloud from 3D image data obtained by 3D imaging device 540. A point cloud may include a three-dimensional representation of a selected objected, such as a vehicle, a wheel, a lug-nut, etc. A point cloud may include information defining the locations of various objects in a 3D coordinate system. For example, a point cloud may define (X, Y, Z) coordinates for an object within a Cartesian coordinate system. A point cloud may additionally include information defining the rotation of an object relative to a defined orientation. For example, rotational information may be represented by rX and rY values representing rotation about x and y axes, respectively. In other embodiments, point cloud generation 632 may use data obtained by other devices such as distance sensors, sonic sensors, etc.

Wheel identification learning model 634 is adapted to identify a wheel within an image.

In one embodiment, wheel identification learning model 634 is a machine learning model trained to identify, classify and/or infer from a digital image of a vehicle wheel a type of wheel. Wheel identification learning model 634 may use any suitable machine learning training technique. Examples of machine learning training techniques that may be used include, but are not limited to, a neural net based algorithm, such as Artificial Neural Network, Deep Learning; a robust linear regression algorithm, such as Random Sample Consensus, Huber Regression, or Theil-Sen Estimator; a kernel based approach like a Support Vector Machine and Kernel Ridge Regression; a tree-based algorithm, such as Classification and Regression Tree, Random Forest, Extra Tree, Gradient Boost Machine, or Alternating Model Tree; Naive Bayes Classifier, and others suitable machine learning algorithms.

Wheel identification learning model 634 may be trained with a training sample of multiple images of wheels. Using the trained model in a production mode, wheel identification learning model 634 may identify a wheel based on a received image as an input to the trained neural network.

Lug-nut identification learning model 636 is adapted to identify one or more lug-nuts based on image data and other information. In one embodiment, lug-nut identification learning model 636 is a machine learning model trained to identify, classify and/or infer from a digital image of a vehicle wheel a type of lug nut pattern, a type of lug nut (i.e., generally referred to as a wheel fastener) and/or a type of lug nut lock. Lug-nut identification learning model 636 may use any suitable machine learning training technique. Examples of machine learning training techniques that may be used include, but are not limited to, a neural net based algorithm, such as Artificial Neural Network, Deep Learning; a robust linear regression algorithm, such as Random Sample Consensus, Huber Regression, or Theil-Sen Estimator; a kernel based approach like a Support Vector Machine and Kernel Ridge Regression; a tree-based algorithm, such as Classification and Regression Tree, Random Forest, Extra Tree, Gradient Boost Machine, or Alternating Model Tree; Naive Bayes Classifier, and others suitable machine learning algorithms.

Lug-nut identification learning model 636 may be trained with a training sample of multiple images of lug nut locks. Using the trained model in a production mode, lug-nut identification learning model 636 may identify a lug nut type on a wheel based on a received image as an input to the trained neural network. In response to determining the type of lug nut lock, lug-nut identification learning model 636 may also indicate a required socket needed to remove the type of lug nut lock.

Lug-nut identification learning model 636 may be trained with a training sample of multiple images of a 4-pattern, 5-pattern, 6-pattern, or 8 pattern lug nut configurations. Using the trained model in a production mode, lug-nut identification learning model 636 may identify a lug nut pattern on a vehicle wheel from a received image as an input to the trained neural network.

In accordance with an embodiment, information relating to the dimensions of a vehicle is obtained. A robotic apparatus is moved to a first position proximate the vehicle. One or more images of the vehicle are captured by the robotic apparatus. A reference point on the vehicle is defined based on the image data. The robotic apparatus is moved to a second position proximate the vehicle based on the reference point.

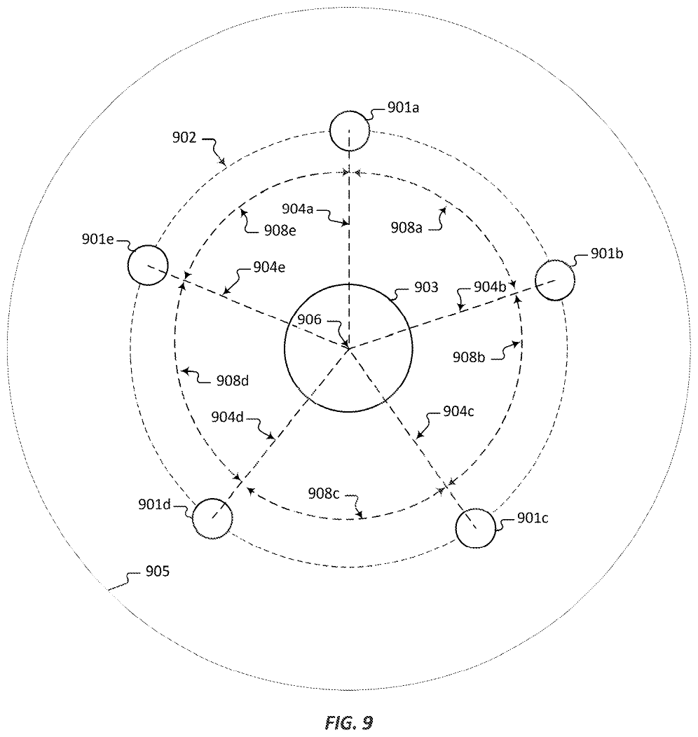

With reference now to FIGS. 9 & 10, a method for determining true position of the lug-nuts of a wheel in order to position the robotic apparatus 150 for automatic lug-nut removal/replacement will be disclosed. FIG. 9 depicts the geometry of an exemplary wheel 905 having, in this example, five lugs 901a-901e. It will be understood that the present method may be applied to any wheel having at least three lugs 901. Lugs 901 are disposed on a circle 902, each at radius 904a-904e from an unknown true center 906 defined by the circle 902. Lugs 901 are distributed at angle 908a-908e from adjacent lugs 901 where all radii 904a-e are substantially equal and all angles 908a-e are substantially equal.

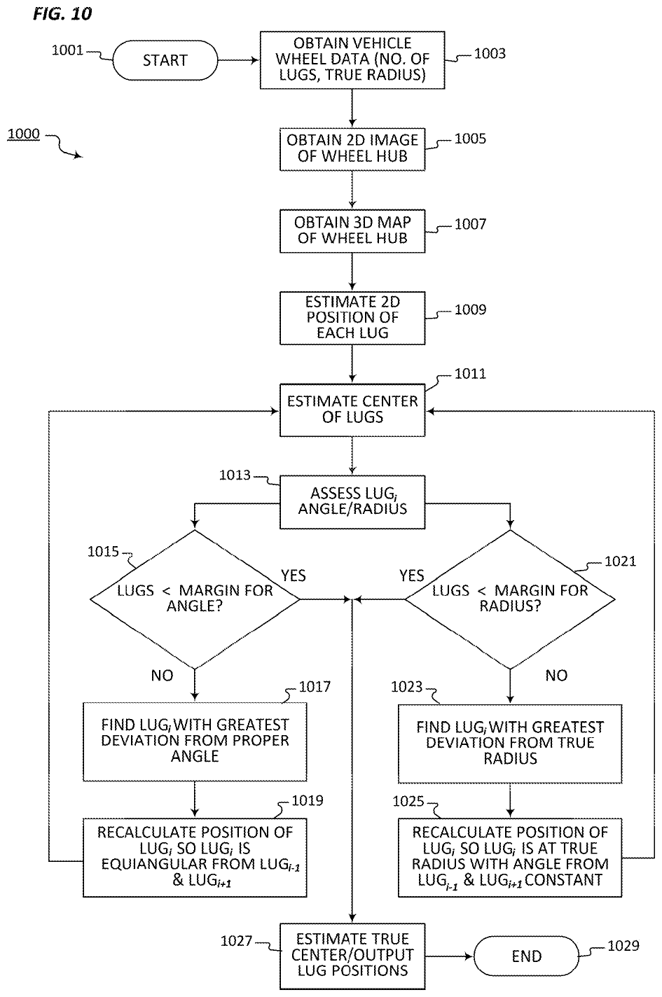

FIG. 10 presents a flowchart of an exemplary method for determining the positions of lugs 901 in a two-dimensional plane. Beginning and Step 1003, vehicle wheel data is obtained, this data including the number of lugs and the radius of lugs. This information is provided by the wheel/vehicle manufacturer associated with the VIN. At Step 1005, a two-dimensional image of the wheel hub is obtained, and at Step 1007 a three-dimensional image of the wheel hub is obtained. Next, Step 1009, the position, i.e., two-dimensional coordinates of each lug 901 (LUGᵢ) is estimated. Then, the true center 906 of the circle 902 defined by the lugs 901 is estimated at Step 1011.

Thereafter, Step 1013, for each LUGᵢ, the angle(s) to its adjacent LUGᵢ is assessed (Step 1015) as well as the radius (Step 1021). At Step 1015, the angle of LUGᵢ to LUGᵢ₋₁ (and LUGᵢ₊₁) is compared to the “proper angle” 908, which is 360° divided by the number of lugs 901. For example, for a wheel with five lugs 901, the “proper angle” is 360/5 or 72°. If any of the estimated angles of LUGᵢ differ from the proper angle by some difference greater than a pre-determined margin, LUGᵢ with the greatest deviation from the proper angle is identified at Step 1017 and its coordinates are re-calculated so that the angles from LUGᵢ₋₁ to LUGᵢ and LUGᵢ to LUGᵢ₊₁ are equal (Step 1019) The pre-determined margin may be, for example, about [+/−X°]. The method returns to Step 1011 where the center is estimated again with the updated LUGᵢ. This process is performed iteratively until the differences of angles of LUGᵢ to LUGᵢ₋₁ and LUGᵢ₊₁ compared with the proper angle are within the predetermined margin.

Similarly, Step 1021 assesses the radius of each LUGᵢ from the estimated center against the true radius obtained at Step 1003 to determine whether any deviation is within a predetermined margin of error, which may be, for example, about +/−0.5 mm. If so, the LUGᵢ with the greatest deviation from the true radius is identified at Step 1023 and the coordinates are recalculated so that LUGᵢ is at the true radius while the angles to adjacent LUGᵢ are held constant (Step 1023). The process is performed iteratively until the difference of the radius of each LUGᵢ from the true radius is within the predetermined margin.

Once the differences of all angles of each LUGᵢ compared with the proper angle and the differences of all radii of each LUGᵢ compared with the true radius are within the predetermined margin, the method proceeds to Step 1027 where the estimated two-dimensional coordinates of the true center and the two-dimensional coordinates of the lug positions is provided.

In various embodiments, the method steps described herein, including the method steps described in FIG. 10, may be performed in an order different from the particular order described or shown. In other embodiments, other steps may be provided, or steps may be eliminated, from the described methods.

Systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatus, and methods described herein may be used within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc.

Systems, apparatus, and methods described herein may be implemented using a computer program product tangibly embodied in an information carrier, e.g., in a non-transitory machine-readable storage device, for execution by a programmable processor; and the method steps described herein, including one or more of the steps of FIG. 10, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

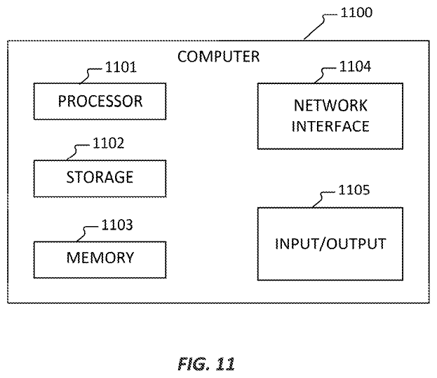

A high-level block diagram of an exemplary computer that may be used to implement systems, apparatus and methods described herein is illustrated in FIG. 11. Computer 1100 includes a processor 1101 operatively coupled to a data storage device 1102 and a memory 1103. Processor 1101 controls the overall operation of computer 1100 by executing computer program instructions that define such operations. The computer program instructions may be stored in data storage device 1102, or other computer readable medium, and loaded into memory 1103 when execution of the computer program instructions is desired. Thus, the method steps of FIG. 10 can be defined by the computer program instructions stored in memory 1103 and/or data storage device 1102 and controlled by the processor 1101 executing the computer program instructions. For example, the computer program instructions can be implemented as computer executable code programmed by one skilled in the art to perform an algorithm defined by the method steps of FIG. 10. Accordingly, by executing the computer program instructions, the processor 1101 executes an algorithm defined by the method steps of FIG. 10. Computer 1100 also includes one or more network interfaces 1104 for communicating with other devices via a network. Computer 1100 also includes one or more input/output devices 1105 that enable user interaction with computer 1100 (e.g., display, keyboard, mouse, speakers, buttons, etc.).

Processor 1101 may include both general and special purpose microprocessors, and may be the sole processor or one of multiple processors of computer 1100. Processor 1101 may include one or more central processing units (CPUs), for example. Processor 1101, data storage device 1102, and/or memory 1103 may include, be supplemented by, or incorporated in, one or more application-specific integrated circuits (ASICs) and/or one or more field programmable gate arrays (FPGAs).

Data storage device 1102 and memory 1103 each include a tangible non-transitory computer readable storage medium. Data storage device 1102, and memory 1103, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 1105 may include peripherals, such as a printer, scanner, display screen, etc. For example, input/output devices 1105 may include a display device such as a cathode ray tube (CRT) or liquid crystal display (LCD) monitor for displaying information to the user, a keyboard, and a pointing device such as a mouse or a trackball by which the user can provide input to computer 1100.

Systems and apparatus discussed herein, and components thereof, may be implemented using a computer such as computer 1100.

One skilled in the art will recognize that an implementation of an actual computer or computer system may have other structures and may contain other components as well, and that FIG. 11 is a high-level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

What is claimed is:

1. A system for performing maintenance of a vehicle wheel comprising:
a robotic apparatus adapted to remove and replace a vehicle wheel;
a processing device communicatively coupled to the robotic apparatus, the processing device comprising:
a memory storing computer program instructions; and
a processor communicatively coupled to the memory, the processor configured to execute the computer program instructions which, when executed on the processor, cause the processor to perform a method comprising the steps of:
obtaining vehicle data, the vehicle data comprising a number of lugs disposed in a vehicle wheel and a true radius of the lugs from a wheel center;
estimating a position of each lug;
estimating a center of the vehicle wheel;
iteratively adjusting an estimated position of each lug; and
providing an estimated true center and estimated new lug positions for each lug.

2. The system of claim 1, wherein iteratively adjusting an estimated position of each lug comprises:
iteratively comparing estimated angles between each lug and each lug adjacent thereto to a proper angle;
if an estimated angle deviates from the proper angle by more than a pre-determined margin of degree, identifying the estimated lug position with the greatest angular deviation and calculating a new estimated lug position for the identified lug position such that the angles between the new estimated lug position and adjacent estimated lug positions are equal; and
re-estimating a new center assuming the new estimated lug position;

3. The system of claim 1, wherein iteratively adjusting an estimated position of each lug comprises:
iteratively comparing an estimated radius of each estimated lug position from the estimated center to the true radius;
if an estimated radius deviates from the true radius by more than a pre-determined margin of distance, identifying the estimated lug position with the greatest radial deviation and calculating the new estimated lug position so that the radius of the new estimated lug position is equal to the true radius and the angles from the new estimated lug position are constant; and
re-estimating a new center assuming the new estimated lug position.

4. The system of claim 1, further comprising a two-dimensional imaging device responsive to the processor and wherein the method performed by the processor further comprises the step of obtaining a two-dimensional image of the vehicle wheel.

5. The system of claim 4, further comprising a three-dimensional imaging device responsive to the processor and wherein the method performed by the processor further comprises the step of obtaining a three-dimensional map of the vehicle wheel.

6. The system of claim 1, further comprising a three-dimensional imaging device responsive to the processor and wherein the method performed by the processor further comprises the step of obtaining a three-dimensional map of the vehicle wheel.

7. The system of claim 1, further method performed by the processor further comprises:
instructing the robotic apparatus to remove lug nuts from the vehicle wheel at each of the estimated new lug positions.

8. A computer-implemented method for finding the positions of lug nuts on a vehicle wheel, the method comprising the steps of:
obtaining a number of lugs disposed in a vehicle wheel and a true radius of the lugs from wheel center;
estimating a position of each lug;
estimating a center of the vehicle wheel;
iteratively adjusting an estimated position of each lug; and
providing an estimated true center and estimated new lug positions for each lug.

9. The method of claim 8, wherein iteratively adjusting an estimated position of each lug comprises:
iteratively comparing estimated angles between each lug and each lug adjacent thereto to a proper angle; and
if an estimated angle deviates from the proper angle by more than a pre-determined margin of degree, identifying the estimated lug position with the greatest angular deviation and calculating a new estimated lug position for the identified lug position such that the angles between the new estimated lug position and adjacent estimated lug positions are equal; and
re-estimating a new center assuming the new estimated lug position; and

10. The method of claim 8, wherein iteratively adjusting an estimated position of each lug comprises:
iteratively comparing an estimated radius of each estimated lug position from the estimated center to the true radius;
if an estimated radius deviates from the true radius by more than a pre-determined margin of distance, identifying the estimated lug position with the greatest radial deviation and calculating the new estimated lug position so that the radius of the new estimated lug position is equal to the true radius and the angles from the new estimated lug position are constant; and
re-estimating a new center assuming the new estimated lug position.

11. The method of claim 8, further comprising the step of:
obtaining a two-dimensional image of the vehicle wheel.

12. The method of claim 8, further comprising the step of:
obtaining a three-dimensional map of the vehicle wheel.

13. The method of claim 8, further comprising the step of:
instructing the robotic apparatus to remove lug nuts from the vehicle wheel at each of the estimated new lug positions.

14. A non-transitory computer storage that stores executable program instructions that, when executed by one or more computing devices, configure the one or more computing devices to perform operations comprising:
obtaining a number of lugs disposed in a vehicle wheel and a true radius of the lugs from wheel center;
estimating a position of each lug;
estimating a center of the vehicle wheel;
iteratively adjusting an estimated position of each lug; and
providing an estimated true center and estimated new lug positions for each lug.

15. The non-transitory computer storage of claim 14, wherein iteratively adjusting an estimated position of each lug comprises:
iteratively comparing estimated angles between each lug and each lug adjacent thereto to a proper angle; and
if an estimated angle deviates from the proper angle by more than a pre-determined margin of degree, identifying the estimated lug position with the greatest angular deviation and calculating a new estimated lug position for the identified lug position such that the angles between the new estimated lug position and adjacent estimated lug positions are equal; and
re-estimating a new center assuming the new estimated lug position; and

16. The non-transitory computer storage of claim 14, wherein iteratively adjusting an estimated position of each lug comprises:
iteratively comparing an estimated radius of each estimated lug position from the estimated center to the true radius;
if an estimated radius deviates from the true radius by more than a pre-determined margin of distance, identifying the estimated lug position with the greatest radial deviation and calculating the new estimated lug position so that the radius of the new estimated lug position is equal to the true radius and the angles from the new estimated lug position are constant; and
re-estimating a new center assuming the new estimated lug position.

17. The non-transitory computer storage of claim 14, further comprising the instructions of:
obtaining a two-dimensional image of the vehicle wheel.

18. The non-transitory computer storage of claim 14, further comprising the instructions of:
obtaining a three-dimensional map of the vehicle wheel.

19. The non-transitory computer storage of claim 14, further comprising the instructions of:
instructing the robotic apparatus to remove lug nuts from the vehicle wheel at each of the estimated new lug positions.

20. A method for automated vehicle wheel removal comprising the steps of:
determining lug-nut pattern for a wheel;
determining a physical geometry of the wheel by a method comprising the steps of:
obtaining a number of lugs nuts disposed in the wheel and a true radius of the lugs from wheel center;
estimating a position of each lug;
estimating a center;
iteratively comparing estimated angles between each lug and each lug adjacent thereto to a proper angle;
if an estimated angle deviates from the proper angle by more than a pre-determined margin of degree, identifying the estimated lug position with the greatest angular deviation and calculating a new estimated lug position for the identified lug position such that the angles between the new estimated lug position and adjacent estimated lug positions are equal;
re-estimating a new center assuming the new estimated lug position;
iteratively comparing an estimated radius of each estimated lug position from the estimated center to the true radius;
if an estimated radius deviates from the true radius by more than a pre-determined margin of distance, identifying the estimated lug position with the greatest radial deviation and calculating the new estimated lug position so that the radius of the new estimated lug position is equal to the true radius and the angles from the new estimated lug position are constant;
re-estimating a new center assuming the new estimated lug position; and
providing an estimated true center and estimated new lug positions for each lug; and
causing a robotic apparatus to remove the lug nuts.
